(19) United States
(12) Patent Application Publication
(10) Pub. No.: US 2004/0024493 A1
(43) Pub. Date: Feb. 5, 2004

(54) Method, system, and sub-system, for processing a chemical reaction

(76) Inventors: Magnus Fagrell, Uppsala (SE); Erik Olaisson, Uppsala (SE)

Correspondence Address: HARNESS, DICKEY & PIERCE, P.L.C., P.O. Box 8910, Reston, VA, 20195, US

(21) Appl. No.: 10/447,280

(22) Filed: May 29, 2003

Related U.S. Application Data
(63) Continuation-in-part of application No. 09/849,489, filed on May 7, 2001.

(30) Foreign Application Priority Data
May 8, 2000 (DK) 2000-000759

(51) Int. Cl. G05B 21/00

(52) U.S. Cl. 700/266

(57) ABSTRACT

Methods, systems, and sub-systems, for processing at least one chemical reaction, including one or more of constructing at least one chemical reaction query, searching at least one database using the at least one chemical reaction query, receiving at least one hit from the at least one database in response to the at least one chemical reaction query, selecting at least one desired hit from the at least one hit, creating the at least one chemical reaction using the at least one desired hit as a template, conducting the at least one chemical reaction using a reaction apparatus, and documenting at least one result of the at least one chemical reaction.

### CROSS-REFERENCE TO RELATED APPLICATIONS

This U.S. nonprovisional patent application is a continuation-in-part of application Ser. No. 09/849,489 filed on May 7, 2001, which claims the benefit of Danish Application PA 2000-000759 filed on May 8, 2000, the entire contents of each of which are hereby incorporated by reference in their entirety.

### BACKGROUND OF THE INVENTION

Automated synthesis and diagnostic processes has met increasing interest in the last decades. In view of the need for standardised processes yielding product and results of uniform quality, a number of useful systems and methods for synthesis and diagnostic processes have been developed. A wide range of systems are commercially available, especially in the field of peptide and oligonucleotide synthesis where standardised synthetic steps can be described in great detail. In peptide and oligonucleotide synthesis standard protocols have been developed so that synthesis thereof can be effected in an automated manner.

A field of great interest is the field of development of novel organic compounds, e.g. novel drug candidates. Some of the major obstacles for an organic chemist today are the time consumed, the complexity, and the search for efficient routes in organic synthesis. As an example, the average performance some ten years ago was around 25-50 complete substances per chemist a year in the pharmaceutical industry, resulting in an equal amount of new chemical entities as potential new drug candidates. Today the figure is close to 100's per year and will soon be expected to be in the region of 1000's per year per day.

Thus, the challenges for the pharmaceutical industry and the organic chemist include identification of ways of reducing time in the drug development, identification of ways of creating chemical diversity, development of new synthesis routes and reintroduction of old “impossible” synthetic routes. Also, it is a constant challenge to reach classes of totally new chemical entities.

Microwaves assisted chemistry offers a way of providing solutions to at least some of the above problems, namely by speeding up the reaction time with orders of magnitude, improving the yield of chemical reactions, offering higher purity of the resulting product due to rapid heating and thereby reducing impurities from side reactions, and making reactions which were not considered feasible with conventional thermal heating possible.

However, it has often been considered difficult to select conditions for an organic transformation independent if it is based on conventional methods or the use of microwave dielectric heating in that suitable reaction conditions often are found within a very narrow “window”. In particular, it is usually considered quite difficult to determine the most suitable combination of process parameters, e.g. applied power, time, solvent, etc.

Although the organic chemist has knowledge about a wide variety of chemical reaction types, he will, if possible, tend to select familiar reaction types even when totally new chemical entities are to be synthesised. Thus, for the organic chemist, it would be desirable if he could gain access to “novel” reaction types associated with reagents unfamiliar to him in a easy manner. The automated synthesis of novel drug candidates and other complex chemical entities should not be limited to “chemistries” developed by the organic chemist operating the system.

There is thus a need for a flexible set-up where the organic chemist can explore a number of reactions without the need for detailed literature studies. This will make it possible for the organic chemist to perform a number of reactions (R reactions) in order to become familiarised with the reaction type. This appears to be especially relevant in the cases where the organic chemist is utilising microwave assisted chemical reactions.

U.S. Pat. No. 5,800,784 describes a chemical treatment cassette for enabling the performance of various complex chemistries with minimal human intervention. It is described that the cassette includes a machine readable code set for identifying the exact chemical treatment protocols required for the samples in the cassette. Thus, the machine readable code set substitutes the manual instructions normally provided to a system so that the cassettes can be processed independent of human intervention. However, in U.S. Pat. No. 5,800,784, the machine readable code set and thereby the exact chemical treatment protocols should still be defined and selected by the user prior to the processing of the samples.

### SUMMARY OF THE INVENTION

Exemplary embodiments of the present invention are directed to methods, systems, and sub-systems, for processing at least one chemical reaction, including one or more of constructing at least one chemical reaction query, searching at least one database using the at least one chemical reaction query, receiving at least one hit from the at least one database in response to the at least one chemical reaction query, selecting at least one desired hit from the at least one hit, creating the at least one chemical reaction using the at least one desired hit as a template, conducting the at least one chemical reaction using a reaction apparatus, and documenting at least one result of the at least one chemical reaction.

### BRIEF DESCRIPTION OF THE DRAWINGS

FIG. 1 illustrates a system in accordance with an exemplary embodiment of the present invention.

FIG. 2 illustrates a preparation of reaction mixtures and treatments according to reaction mixtures in accordance with an exemplary embodiment of the present invention.

FIG. 3 illustrates a flowchart in accordance with an exemplary embodiment of the present invention.

FIG. 4 illustrates a workflow in accordance with an exemplary embodiment of the present invention.

It should be emphasized that the drawings of the instant application are not to scale but are merely schematic representations, and thus are not intended to portray the specific dimensions of the exemplary embodiments of the present invention, which may be determined by skilled artisans by examination of the disclosure herein.

### DESCRIPTION OF EXEMPLARY EMBODIMENTS OF THE PRESENT INVENTION

Even in view of the known methods for conducting chemical reactions, there is still a need for a method for conducting a plurality of chemical reactions where the user (chemist or technician) simply by providing information about the chemical structure (or at least the functionality or functionalities involved in the chemical reaction) of one or more substrates (chemical species) and the desired transformation (reaction) is able to have the substrate(s) reacted in the presence of one or more reagents (chemical substances) under potentially feasible conditions in order for the user to be directed to substantially optimal reaction condition. The present invention describes exemplary embodiments which provide the above.

An Exemplary Method of Conducting a Chemical Reaction

Exemplary embodiments of the present invention relate to a method of conducting R chemical reactions.

Generally, the term “chemical reaction” (as well as the synonymous term “transformation”) should be interpreted in the broadest sense. Examples of “chemical reactions” range from (a) the formation of new chemical entities (covalent bond formation) via the reaction of a chemical species with one or more reagents optionally under the influence of a catalyst, over (b) formation of salts (ionic bond formation) (c) to isomerisation/rearrangement of chemical species (d) racemisation of chemical species. Exemplary embodiments of the present invention may be particularly useful for the formation of new chemical entities (covalent bond formation). For all these types of chemical reactions, an (unknown) optimal set of reaction parameters is believed to exist. Exemplary embodiments of the present invention can make it possible for a person to gain access to useful set of reaction parameters and to perform a series (R) of reactions substantially without the requirement for manual intervention. This is particularly true when the method is facilitated by a kit including amounts of suitable reactants, catalysts, etc. which may be required or useful for the chemical reaction in question.

The chemical reaction may broadly speaking involve one or more chemical species jointly designated “B”; e.g. “the starting material(s)”), one or more chemical substances jointly A; e.g. a reagent) and optionally one or more catalysts (e.g. enzyme(s)) thereby leading to the desired product (D). Said chemical species (e.g. starting material(s)) can be chemical entities in any phase, e.g. solid phase, liquid phase or gas phase, preferably solid phase or gas phase. From the above, it should be understood that the reaction may include two (or more) starting materials (B's), e.g. in the instances where the reaction (transformation) involves the coupling of two chemical species or a condensation reaction involving two or more chemical species. Thus, when used herein, the symbol “B” as well as ^{X}B, ^{N}B, and the like should be interpreted as covering one or more chemical species, each of which are considered as substrates, that is the chemical species which the user have in hand for the purpose of the overall transformation defined by the user. This will be discussed in detail further below.

Examples of interesting chemical reactions (transformations) within the present context include, but are not limited to, organic reactions e.g. polymerisation/-oligomerisation, esterification, decarboxylation, hydrogenation, dehydrogenation, addition such as 1,3-dipolar addition, oxidation, isomerisation, acylation, alkylation, amidation, arylation, Diels-Alder reactions such as maleinisation and fumarisation, epoxidation, formylation, hydrocarboxylation, hydroboration, halogenation, hydroxylation, hydrometallation, reduction, sulphonation, aminomethylation, ozonolysis, C—C coupling reactions (e.g. Stille, Heck and Suzuki reactions), etc. The system and method according to exemplary embodiments of the present invention may be especially suited for reactions involving one or more catalysts and for asymmetric organic reactions.

The chemical reaction may take place in a suitable solvent or in neat form. Suitable solvents may, as will be acknowledged by the person skilled in the art, depend on the chemical reactions to be conducted. When a solvent is used in a microwave assisted chemical reaction (that is if the apparatus provides microwave energy for the purpose of heating), the dissipation factor (or loss tangent) of the solvent may be greater than about 0.04 at 20° C. Examples of suitable solvents for microwave assisted chemical reactions include, but are not limited to acetonitrile, DMF, DMSO, NMP, water, tert-butanol, EtOH, benzonitrile, ethylene glycol, acetone, THF and ionic liquids, as disclosed in WO 00/72956, which is hereby incorporated by reference in its entirety.

With respect to exemplary embodiments of the present invention, a chemical reaction can generally be considered as involving one or more chemical species ^{X}B (which may be the selected starting material(s) or substrate(s) for the chemical reaction) and resulting in a reaction product ^{X}D (which is the desired product of the chemical reaction defined by the user). It should furthermore be understood that the reaction product may include a functionality δ and that the chemical reaction involves one or more functionalities β in the ^{X}B's, which are transformed into δ in ^{X}D. The prefix “X” indicates that the symbols B and D are associated and they represent the chemical reaction for which the reaction parameters are to be found (yet unknown=X). It should be understood that each of the ^{X}B's may include more than one functionality β, e.g. in the instance where the desired product is a lactone (δ≈ester bond; β's≈alcohol and acid, respectively).

Hence, a chemical reaction can generally be considered as the following transformation:

^{X}B(β)→^{X}D(δ)

where the part of ^{X}B not being included in the functionality/functionalities β is substantially preserved as the part of ^{X}D not being included in the functionality δ. This being said, especially with respect to the description further below, the chemical reaction is typically conducted under the influence of one or more chemical substances A. Such chemical substances A include a functionality α which is involved in the transformation of the β's into δ. The substance(s) A may be specific reagent(s) or may be a solvent which includes groups useful for facilitating the transformation above. This being said, the functionality α of A need not to be covalently coupled to the functionality β, although this may be the case.

In an exemplary embodiment, the chemical reaction may be considered as the following transformation:

A(α)+^{X}B(β)→^{X}D(δ)

In another exemplary embodiment, the reaction may involve one or more chemical species ^{X}B (i.e. starting material(s) selected by a user wherein the chemical reaction is to be conducted) and resulting in a reaction product ^{X}D (e.g. the desired product) which includes a functionality δ, where the chemical reaction involves one or more functionalities β (e.g. a carboxylic acid functionality) in the ^{X}B's which are transformed into δ (e.g. an carboxylic ester functionality) in ^{X}D.

In an exemplary embodiment, the chemical species (^{X}B) may be cyclohexyl-1carboxylic acid and the desired product (^{X}D) may be benzyl cyclohexyl-1-carboxylate, where the functionality β included in ^{X}B is —COOH which is to be transformed to the ester —COOBn, thus, δ in ^{X}D is —COOBn. In this instance, A could be BnCl, i.e. α=—Cl.

Another exemplary embodiment is the oxidation of benzylalcohol to benzoic acid

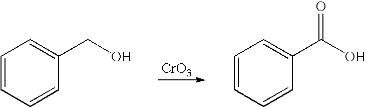

wherein B is benzyl alcohol with the hydroxyl group being the functionality β and CrO₃ as the chemical substance A and benzoic acid being the product D with the carboxylic acid group as the functionality δ.

As will be understood, the above simplified description of the reactions also include the possibility of including what could be considered as two (or more) substrates which in a coupling reaction are coupled to each other. In such instances, ^{X}B (the substrate) may actually include two substrates which are then separately or jointly treated with reagents under the conditions identified in the method and are brought together in order to form the coupled product (^{X}D(δ)). In such instances, the functionality β in both (or all) of the chemical species ^{X}B may be provided to the parameter selection unit.

An exemplary embodiment where a transformation including two substrates (B's), namely ^{X}B′ and ^{X}B″ is

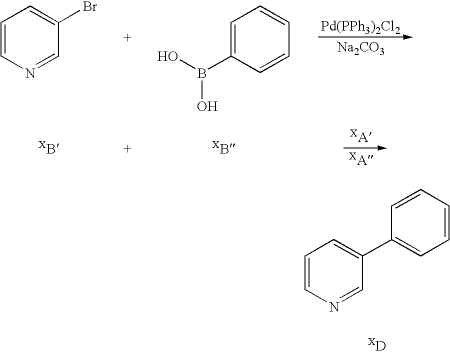

in which 2-bromopyridine is ^{X}B′ and the boronic acid is ^{X}B″, β′ is Br and β″ is B(OH)₂, whereas δ may be a single bond.

The R reactions may be conducted in a system which provides energy for the chemical reactions. The term “provides energy” should be understood in the broadest sense, namely that the apparatus may be able to actively heat the reaction mixtures (as described below) or the apparatus may simply be able to provide the correct conditions with respect to temperature (including cooling), pressure, atmosphere, etc. so that the reactions are energetically favoured and allowed to proceed according to the R sets of reaction parameters (^{X}Σ_{R}). In exemplary embodiments of the present invention, the apparatus provides energy to the reactions in the form of heat, in particular by heating with microwaves.

Besides including an apparatus for providing energy to the reaction, the system may also include a parameter selecting unit having a user interface and storage for carrying a database. The parameter selecting unit may also comprise an apparatus control unit for communicating with the apparatus. The apparatus may comprise a liquid handler for preparing the reaction mixtures and a reaction cavity for treating the reaction mixtures (providing the reaction conditions). In addition, the apparatus control unit may communicate with an analysis unit. The system may be constructed so that the user interface, such as a graphical user interface (GUI), may be connected to the storage via a search unit in order to access the database. The storage may be available directly in the form of a hard disk, CD-ROM, etc. or via the internet, a server network, website, or the like. The search in the database may be performed by a substructure search for a desired chemical reaction (transformation A(α)+^{X}B(β)→^{X}D(δ)). The data retrieved from the database may be edited in the apparatus control unit to fit the specification of the user or used directly, without intervention by the user. The apparatus control unit may then send an instruction to the liquid handler with information for the reaction, such as making stock solutions, diluting, mixing the reagent(s), mixing in general, etc. The liquid handler unit may perform these steps using a robotic arm with a needle connected to a pump but could also be handled with valves and tubing. The robotic arm may also have a gripper that is used for moving the samples into the reaction cavity, e.g. a microwave cavity. The apparatus control unit may also instruct the reaction cavity of the apparatus regarding reaction temperature, pressure, etc. The temperature and pressure in the reaction cavity may be measured during the treatment process. After (or during) the heating process, a sample from the reaction mixture may again be handled by the liquid handler and sent to the analysis unit in order to follow the reaction. All data generated from each unit may be sent back to the storage and stored for later use. Such data may be used for building the database, for repeating reactions, etc. The user could also use the parameter selection unit as a office client via a network, web interface, through a firewall and via internet. The data could be stored on a server, hard disk, CD-ROM, etc.

Exemplary embodiments of the present invention may be conducted in a semi-automated or automated manner by utilising a computer program adapted for performing the steps of selecting the R sets of reaction parameters, preparing the R reaction mixtures and treating the R reaction mixtures, etc., i.e. facilitating the methods described herein.

As described above, the treatment may include heating. In an exemplary embodiment, the reaction is a microwave facilitated chemical reaction, wherein treatment is application of microwaves to the reaction mixture. Such a reaction may be performed in a microwave reaction cavity of a microwave apparatus.

Such a microwave apparatus may comprises a controllable microwave generating and amplification unit for providing microwaves to the reaction cavity. When such an apparatus is used, the application of microwaves may be controlled by the R selected set of reaction parameters via the controllable microwave generating and amplification unit. One exemplary microwave apparatus to be utilised in connection with the present invention is described in WO 00/36880 which is hereby incorporated by reference in its entirety.

In an exemplary embodiment, the method comprises the step of having the user provide information to the user interface of the parameter selection unit about (at least) the functionality/functionalities β in the chemical species ^{X}B. Thus, information about the functionality/functionalities β in the chemical species ^{X}B may be provided to a parameter selection unit. Such information may be in the form of structural information about the functionality or information in the form of a code referring to the functionality/functionalities β. Through the user interface module, it is possible to either draw the chemical functionalities β and even the partial (more than just the chemical functionality β) or substantially full chemical structure of the chemical species ^{X}B. A user interface module providing this feature can be made available by using standard software products, e.g. ISIS Draw, etc., used for graphical presentation of chemical structure, as such software products that are able to present chemical structures in a standardised manner. Alternatively, the operator may select the functionality from a list of chemical functionalities provided via the user interface.

In an exemplary embodiment, a partial chemical structure (substructure) of ^{X}B may be provided so as to make is possible for the parameter selection unit (via the search unit) to retrieve the most relevant sets of reaction parameters from the database (see below). In an exemplary embodiment, the full chemical structure of ^{X}B may be provided so as to ensure that other functionalities in ^{X}B are also taken into consideration.

Exemplary embodiments of the present method may also comprise the step of having the user provide information to the user interface of the parameter selection unit regarding the desired transformation of β to δ. This information may, as above for β, be given in the form of structural information about the functionality/functionalities δ or information in the form of a code specifically referring to the functionality δ or the specific transformation β→δ. The user may also select the desired transformation from a list of named reactions. Information regarding the partial or complete structure need not be given as the part of ^{X}D not being δ normally is typically essentially identical to the part of ^{X}B not being β. Thus, if the full (or partial) structure of ^{X}B is already provided, information regarding the transformation, or simply about δ, may be sufficient.

After the initial information is provided to the parameter selection unit via the user interface, the system is capable of conducting the R chemical reactions with little or no user intervention. This is particularly true when a kit is provided to the system.

The parameter selection unit may be used for retrieving the R sets of reaction parameters from a database. Thus, the parameter selection unit may include processor for conducting the retrieval, processing/selection. Storage (diskette, CD-ROM, semiconductor memory chip, etc.) for either permanent or temporary storage of data module may be associated with the parameter selection unit. Also, the parameter selection unit may include a neural network sub-module for providing the option of maintaining the database with results of the reactions performed (including yields for example), thereby facilitating a reaction optimisation process.

Exemplary embodiments of the method of the present invention may utilise a database which comprises N sets of associated data, each of the N sets comprising (at least):

i) a set of reaction parameters for a chemical reaction involving the transformation of one or more functionalities ^{N}β of chemical species ^{N}B into ^{N}δ in a product ^{N}D under the influence of one or more chemical substances ^{N}A, such chemical substance(s) each including a chemical functionality ^{N}α being involved in the transformation of the functionality ^{N}β to the functionality ^{N}δ; and

ii) functional or structural information about the chemical species ^{N}B.

The database may have one of many possible formats known to a person skilled in the art. In particular, several commercially available formats are possible, e.g. Beilstein Crossfire, Scifinder, ISIS/Base (Teilheimer, Spore, CIRX, Daylight). The database may be provided on a medium, e.g. a diskette, a hard disk, a CD-ROM, a semiconductor memory chip, etc. In an exemplary embodiment, the database is accessible via the internet. This possibility makes it possible for the user/customer (via the parameter selection unit) to have access (e.g. via an access code) to a database which is provided and maintained by a supplier.

As described above, the database may comprise N sets of “associated data”. The term “associated data” means that a series of data representing information about a chemical reaction may be presented in the database in a way that makes it possible for the parameter selection unit to retrieve such data. One way of traditionally “organising” the database is to present the associated data in separate records, however, as the database also should comprise functional or structural information about the chemical species ^{N}B, it is envisaged that a relational database may also be suitable. In exemplary embodiments, the database schema may be based on records or relational. In exemplary embodiments, the queries may be SQL queries or other chemical formula-based queries, as would be know to one of ordinary skill in the art.

The positive integer N may also be used as a prefix for B, D, β, δ and A thereby indicating that specific B, D, β, δ and A's, respectively, are included in the nth set (n being in the range of 1 to N) of associated data in the database. It will be apparent that N can be any positive integer, however in exemplary embodiments, an integer of at least 4, such as at least 10, in particular at least 25. The total number of sets of associated data may be quite large, e.g. up to 1,000 or even up to 10,000. It should be understood that ^{N}B and ^{N}D in one set of associated data can be the same as in another set of associated data. Actually, this situation simply implies that the same chemical reaction (the transformation ^{N}B→^{N}D) may be performed under different conditions (e.g. involving different A's or different conditions). In particular, the N sets may also comprise sets of associated data corresponding to non-identical sets of ^{N}B and ^{N}B, i.e. not all sets of associated data should relate to the same reaction B→D.

The N sets of associated data may each comprise a set of reaction parameters for a chemical reaction involving the transformation of a functionality ^{N}β of a chemical species ^{N}B into ^{N}δ in a product ^{N}D under the influence of a chemical substance ^{N}A, such chemical substance including a chemical functionality ^{N}α being involved in the transformation of the functionality ^{N}β to the functionality ^{N}δ. Thus, the chemical reactions for which data (sets of reaction parameters) may be stored in the database can be generalised as the transformation

^{N}A(^{N}α)+^{N}B(^{N}β)→^{N}D(^{N}δ).

In exemplary embodiments, the term “set of reaction parameters” is intended to mean a set of parameters which make it possible to conduct a chemical reaction in a reproducible manner. Typical examples of reaction parameters for chemical reactions are parameters with respect to temperature (i.e. temperature level, temperature cycles, etc.), pressure (i.e. initial pressure, maximum pressure, etc.), reaction time, reaction cycles, relative amounts of reactants, time of addition of reactants, etc. As will be apparent, the associated data may also include information regarding addition of additional reagents and/or catalysts, etc. Although not mandatory, it may be advantageous to include information regarding the yield, the pre-run reactions and/or optionally also the purity.

The set of reaction parameters may be presented either as direct parameters (temperature, pressure, etc.) or may be presented as indirect parameters, i.e. control parameters for the apparatus (via the apparatus control unit) which is to provide energy for the chemical reaction. In the latter instance, the set of reaction parameters may be presented as a control parameter protocol which will lead to the desired parameters with respect to temperature, pressure, etc. when used in the apparatus. In exemplary embodiments the set of reaction parameters may also comprise information regarding the intended parameters with respect to temperature, pressure, etc. in that such additional information may be used to monitor the conducted reaction and, in exemplary embodiments, to adjust the control parameters so as to obtain the desired reaction parameters.

Furthermore, it should also be understood that a set of reaction parameters may allow the person in control of the system or an computer associated with the system (e.g. a computer comprising a trained neural network for optimising the reaction conditions) to alter the set of reaction parameters if desirable. However, in exemplary embodiments the parameter selection unit may operate without user intervention.

The N sets of associated data may also each comprise functional and/or structural information regarding the chemical species ^{N}B. In an exemplary embodiment, information regarding the functionality ^{N}β should be given (functional information). In another exemplary embodiment, further information regarding the partial or full chemical structure (structural information) may also given in order to make it possible to compare the chemical structure of the ^{N}B's and ^{X}B. This will, as mentioned above, make it possible to take into consideration the impact of other potentially reactive functionalities within ^{X}B.

The N sets of associated data may also comprise information regarding the functionality δ, and/or information regarding the chemical substances ^{N}A, in particular the functionality ^{N}α, and/or further partial or full structural information.

In an exemplary embodiment, none of the N sets of associated data in the database need exactly correspond to a transformation of ^{X}B into ^{X}D. This means that the desired reaction (involving the transformation of a specific ^{X}B to a specific ^{X}D) has not been performed in advance, and the full impact of exemplary embodiments of the present invention with respect to retrieval and selection may then be exploited.

Exemplary embodiments of the method may also comprise the further step of allowing the parameter selection unit to retrieve R sets of associated data (Σ_{R}) from the database, such sets of associated data being selected so that the functionality ^{N}β in each set of associated data is essentially identical to the functionality/functionalities β in ^{X}B and the functionality ^{N}δ is essentially identical to δ in the product ^{X}D. The term “essentially identical” indicates that the functionalities taken as such may be structurally identical, but that certain differences might appear, especially with respect to reactivity (electron distribution, sterical hindrance, etc.).

It will be apparent that the provided information regarding ^{X}β and ^{X}δ may have the same level of specificity as the information regarding ^{N}β and ^{N}δ. This may be accounted for when constructing the parameter selection unit and building the database.

In an exemplary embodiment, the result of the desired reaction (or reactions in an optimisation procedure) may be provided to the database so as to extend the knowledge accumulated. In connection herewith, it may be relevant to provide information about the yield and/or the purity.

It should also be understood that the parameter selection unit may retrieve more than one set of reaction parameters (R>1). It will be apparent that R may be any positive integer (R<=N). The positive integer R may also used as a prefix thereby referring to the rth set (r being in the range of 1 to R) of retrieved data. The R sets of associated data (Σ_{R}) may be retrieved in order to obtain the R sets of reaction parameters (^{X}Σ_{R}).

As will be apparent from the following, R (R>1) sets of reaction parameters may be selected, thereby making it possible to conduct R chemical reactions under fairly realistically reaction conditions with the aim of identifying the best possible conditions for the transformation in question and optionally with the aim of further optimising the reaction conditions. As will be apparent, such an optimisation procedure may be conducted in an iterative manner.

In exemplary embodiments of the present method, the reaction of ^{X}B to give the product ^{X}D under the conditions defined by the sets of reaction parameters (^{X}Σ_{R}) may require the influence of corresponding chemical substances A_{R}, where such chemical substances A_{R} including a chemical functionality α_{R} being involved in the transformation of the functionality β to the functionality δ. In such exemplary embodiments the R sets of reaction parameters may also comprise information about which specific A_{R}'s are required.

The chemical substances A_{R} may be selected so that the functionalities α_{R} thereof resemble the functionalities ^{N}α of the chemical substances ^{N}A retrieved as in the R sets of associated data (Σ_{R}). Thus, the reagents proposed with the R sets of reaction parameters may be of the same type as the ones used in the pre-run reactions represented in the database. (α_{R}≅^{N}α)

In an exemplary embodiment, the R sets of reaction parameters (^{X}Σ_{R}) may be accompanied by corresponding information regarding the chemical substances A_{R} under which influence the R reactions may be conducted. Such information may include, with or without the information regarding the functionality or (full or partial) structure of the A_{R}'s, also comprise information about the amount of chemical substance (number of equivalents), time of addition, etc.

In an exemplary embodiment, the R sets of associated data which are to be retrieved from the database may also include information about any additional constituents involved in the chemical reaction involving the transformation of a functionality ^{N}β of a chemical species ^{N}B into a ^{N}δ in a product ^{N}D under the influence of a chemical substance ^{N}A. Such additional constituents may include catalysts, additional reagents, solvents, reactive gasses, inert atmospheres, etc. In connection therewith, it may be relevant that the R sets of reaction parameters (^{X}Σ_{R}) are accompanied by information about any such additional constituents involved in the chemical reaction.

In an exemplary embodiment of the method of the present invention, chemical substances A_{R} may be reagents. In an exemplary embodiment, the chemical substances A_{R} may be immobilised.

The retrieved R sets of reaction parameters may be selected so as to provide a set of reaction parameters based on the best (sub)structural match between ^{X}B (or the ^{X}B's) and the ^{N}B's in Σ_{Q}, i.e. one set of reaction parameters corresponding to a pre-run reaction which included a similar chemical species.

The terms “structural match” and “structural similarity” may refer to comparative measures which can be performed by available software products incorporated in or collaborating with the parameter selection unit. It should be understood that structural similarity or structural match can also be based on a preselected substructure of the molecule. This is apparent as the information provided to the parameter selection unit may be a substructure of ^{X}B. In order for the parameter selection unit to perform the comparison, one of a number of possible commercial software products can be associated with the parameter selection unit. Examples hereof are ISIS/Base and Beilstein Crossfire and Scifinder as well as several other conventional molecular modelling software packages.

In an exemplary embodiment, the retrieved R sets are used directly as parameters in the R sets of reaction parameters, by using A_{R}'s having the same functionalities α_{R} as the functionalities ^{N}α in the corresponding reaction.

In an exemplary embodiment, the R sets of reaction parameters may involve the use of more than one chemical substance A_{R}. In this manner, various types of chemical substances (e.g. reagents) can be tested under various conditions in an optimisation process (R reactions). In particular, when an initial optimisation process is conducted in order to identify a chemical substance A to be used in a subsequent optimisation process, the R sets of reaction parameters may involve the use of R chemical substances A_{R}. It will be appreciated that various variants may also exist. It should be understood, that in the cases where various A's are to be tested, the R sets of reaction parameters include such information. In one variant, the R sets involve a few A's in combination with a number of different solvent, catalysts, temperature profiles, etc. thereby yielding a complete set for optimisation suggestions.

When the R sets of reaction parameters are selected, the array of R reaction mixtures each comprising an amount of the chemical substance A_{R} and the chemical species ^{X}B and any additional constituents required may be prepared according to the sets of reaction parameters. It should be understood that the user intervention in connection with this method step may be limited to (i) providing the substrate (^{X}B) (or substrates) in a suitable form, e.g. in solid or liquid or dissolved form in a vial, and/or (ii) providing the necessary reagents (chemical substances), solvents, catalysts, etc. The latter step may be effected by means of a kit in which the necessary constituents are provided in one or more vials which can be handled by a system handler. In an exemplary embodiment, the R sets of reaction parameters may provide sufficient information to the system so that user intervention is reduced or, eliminated.

In an exemplary embodiment, the array of R reaction mixtures may be prepared by combining the chemical species ^{X}B with the content of one or more of P containers each comprising a chemical substance A_{R} including a chemical functionality α_{R} which may facilitate the transformation of a functionality β to a functionality δ in a chemical reaction involving a chemical species ^{X}B.

After the array of R reaction mixtures is provided, each of the R reaction mixtures are treated in the apparatus, for example in the reaction cavity, in accordance with the corresponding set of reaction parameters. The reaction mixture(s) may typically be placed in the reaction cavity by the system handler.

The R reactions may be performed sequentially or, alternatively, substantially simultaneously. In an exemplary embodiment, treatment of the R reactions may be performed substantially simultaneously. In both instances, the user intervention may be eliminated.

The reaction mixtures can be placed directly in the reaction cavity of the apparatus where reaction is effected, but the sample may be placed in an open or closed sample holder or vial. This sample holder or vial can be an integral part of the reaction cavity or a separate reaction vessel of any material suitable for treatment under the conditions defined by the reactions parameters, e.g. microwave heating applications. For microwave heating, it will be known to the person skilled in the art that the material constituting the sample holder need not absorb the microwave energy. Various types of polymers and glasses can advantageously be used. Specifically, various types of trays, microtiter plates, etc. may be used when a plurality of samples are heated simultaneously. In order to avoid contamination, the sample holder or vial may include a lid.

The free space in the reaction cavity can be filled with an inert gas in order to avoid reaction between ambient gasses and the sample. In an exemplary embodiment, the sample holder may include a lid.

The reaction cavity may be able to sustain high internal pressure either caused by the chemical reaction or intentionally to create a high-pressure atmosphere as a reaction parameter. High internal pressure may be used as a method to increase the temperature in the reaction vessel over the boiling point for the liquid phase in the reaction vessel. The pressure can be kept at a desired level or pre-set as a level not to be exceeded or fallen below. The pressure system may incorporate a safety valve function for protection of the pressurised components and personal safety of the operator.

An Exemplary Kit

In exemplary embodiments, the present invention also provides a kit for use in the method. The kit may also comprise additional constituents required for the transformation.

The kit may be useful in that predispensed amounts of various chemical substances may be provided.

It should be understood that the parameters, symbols, etc. have the meaning defined above. The positive integer P may indicate the number of different chemical substances to be used in the R reactions. P is typically >1, such as >3. It should also be understood that one chemical substance may be used in several reactions within an exemplary method for optimising reaction conditions (thus, P<=R).

The kit may be disposable so that the constituents thereof are only used in a series of R chemical reactions. Thus, the method may use the kit for the R chemical reactions that is provided. The kit may be disposed after the R reaction mixtures are prepared.

An Exemplary System

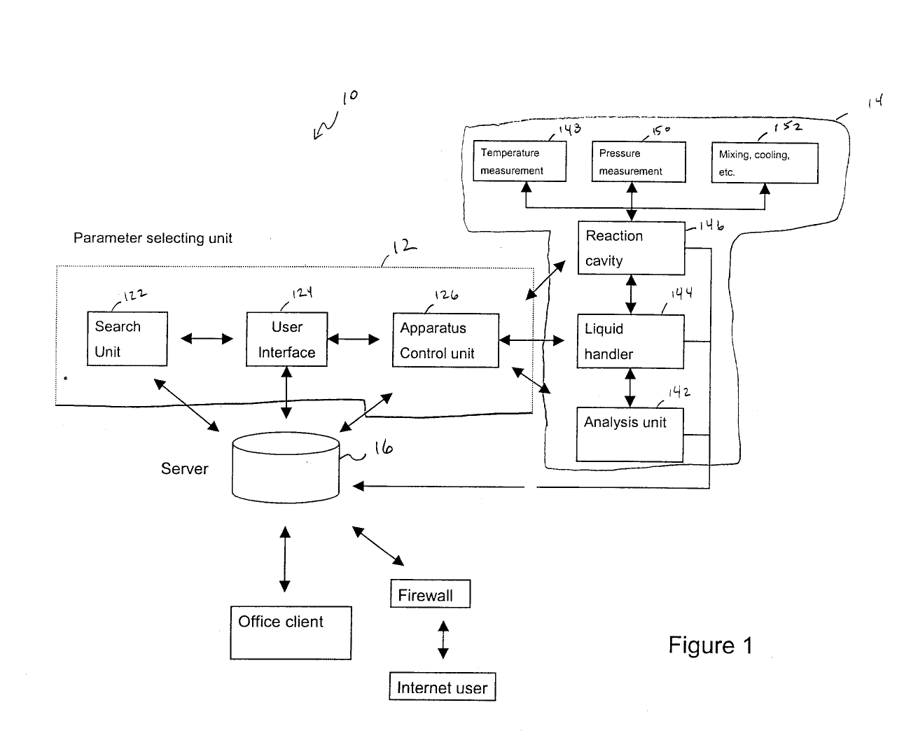

Exemplary embodiments of the present invention also relate to a system. Such an exemplary system is illustrated in FIG. 1. The system may also comprise one or more disposable kits comprising P containers each comprising a chemical substance A_{R} including a chemical functionality α_{R} which is intended to facilitate the transformation of the functionality β to the functionality δ in the chemical reaction.

In an exemplary embodiment, the apparatus of the system is a microwave apparatus, i.e. the reaction cavity is a microwave reaction cavity.

As shown in the exemplary embodiment of FIG. 1, the system 10 may include one or more subsystems, such as a parameter selecting unit 12, a reaction unit 14, and a database 16. As shown in FIG. 1, the parameter selecting unit 12 may include a search unit 122, a user interface 124, and an apparatus control unit 126. As also shown in FIG. 1, the reaction unit 14 may further include an analysis unit 142, a liquid handler 144, a reaction cavity 146, and temperature 148, pressure 150, and/or other measurement 152 units.

In an exemplary embodiment of the system of the present invention are particularly useful for use in the method also defined herein.

Exemplary Software

Exemplary embodiments of the present invention also relate to a computer readable data carrier loaded with a computer program for facilitating the method defined herein in the system defined herein. In an exemplary embodiment, the computer program comprises:

retrieving information via a user interface of the parameter selection unit regarding the functionality/functionalities β in the chemical species ^{X}B;

retrieving information via the user interface of the parameter selection unit regarding the desired transformation of β to δ;

retrieving, via the parameter selection unit, R sets of associated data (Σ_{R}) from the database, such sets of associated data being selected so that the functionality/functionalities ^{N}β in each set of associated data is/are essentially identical to the functionality/functionalities β in ^{X}B and the functionality ^{MN}δ is essentially identical to δ in the product ^{X}D, in order to obtain the R sets of reaction parameters (^{X}Σ_{R}), said R sets of reaction parameters (^{XΣ}_{R}) being accompanied by corresponding information about the chemical substance(s) A_{R} under which influence the R reactions should be conducted and information about any additional constituents involved in the chemical reaction;

providing instructions to a liquid handler regarding the preparation of an array of R reaction mixtures each comprising a predetermined amount of the chemical substance(s) A_{R} and the chemical species ^{X}B and any additional constituents required according to the sets of reaction parameters;

providing instructions to the reaction cavity regarding treatment of each of the R reaction mixtures in the apparatus in accordance with the corresponding set of reaction parameters.

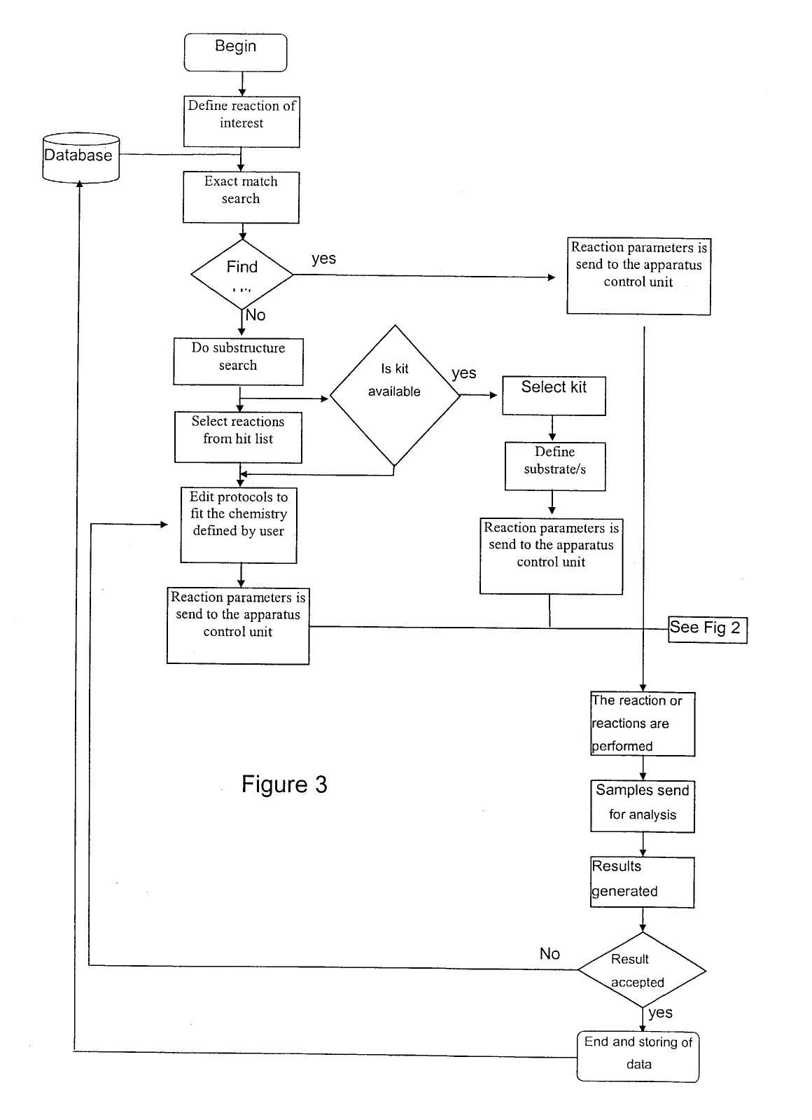

An exemplary embodiment of the functionality of the computer program is illustrated in FIG. 3. The computer readable data carrier can be of any format, e.g. a CD-ROM, a hard disk, a floppy disk, RAM, etc.

Exemplary embodiments of the present invention should furthermore be understood in view of the following non-limiting examples.

### EXAMPLES

The experiments illustrated in the following are feasible within an exemplary system as illustrated in FIG. 1.

An illustrative example is given in the following:

The following product is to be synthesised in the system of the invention.

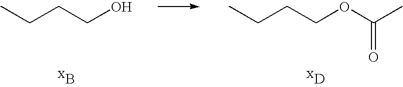

The first step in the method is to provide information to the user interface (i) about the functionality β (—OH) and (ii) about the desired transformation of β to δ (—OH→—O— Acetyl, i.e. acetylation of an alcohol). The user also provides information to the user interface about the full structure of ^{X}B (n-butanol) or the partial structure of ^{X}B (—CH₂—OH; i.e. primary alcohol).

The database may comprise N sets of associated data, i.a. data for the transformation hydroxy groups (^{N}β) of various chemical species (^{N}B) into the acetylated derivative. The database may include associated data for primary, secondary and tertiary alcohols as substrates.

If only the functionality β is provided by the user, the search unit may retrieve the R sets of data among all sets of associated data defining β as an alcohol and defining the transformation, β→δ, as the conversion of an alcohol to the acetylated derivative.

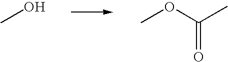

If the user has provided information regarding the full or partial structure of ^{X}B, i.e. information that ^{X}B is a primary alcohol, it is possible for the search unit to retrieve the R sets of associated data corresponding to R sets of data among the associated data in which ^{N}β is a primary alcohol.

In the database, several hits relating to different A, catalyst, solvent, reaction profile etc. may be obtained. As an option, it is possible to indicate in a hit list whether the additional constituents called for by the R′ sets are available chemicals. This will often reduce the number of hits (R) retrieved by the search unit. Another possibility is to reduce the number of hits by setting a yield threshold, or a reaction time threshold, etc. This procedure will reduce the number of R sets of reaction parameters (^{X}Σ_{R}). Also, it is possible to set an upper limit for the number R.

The number of hits may be reduced by checking the availability of the chemicals called for. In an exemplary embodiment, the retrieved R sets of reaction parameters corresponds to a commercially available, disposable reaction kit comprising reagents, for example, including additional constituents, for the R reactions.

The R sets of reaction parameters may then be used directly by transferring the data to the apparatus control unit, optionally after a priori user modification. Reagent A could be a change, a change of reaction temperature, reaction times etc. The information that is transferred to the apparatus control unit may include information for making stock solutions, reagent mixing, reaction temperatures, etc. The instrument may then execute the reaction according to the protocol. After each of the R reactions, a sample for analysis of the reaction mixture may be transferred to a analysis tool such as LC/MS, GC/MS, flow-through probe NMR, etc. The data from different parts may be collected in database server and can be used again for reproducibility.

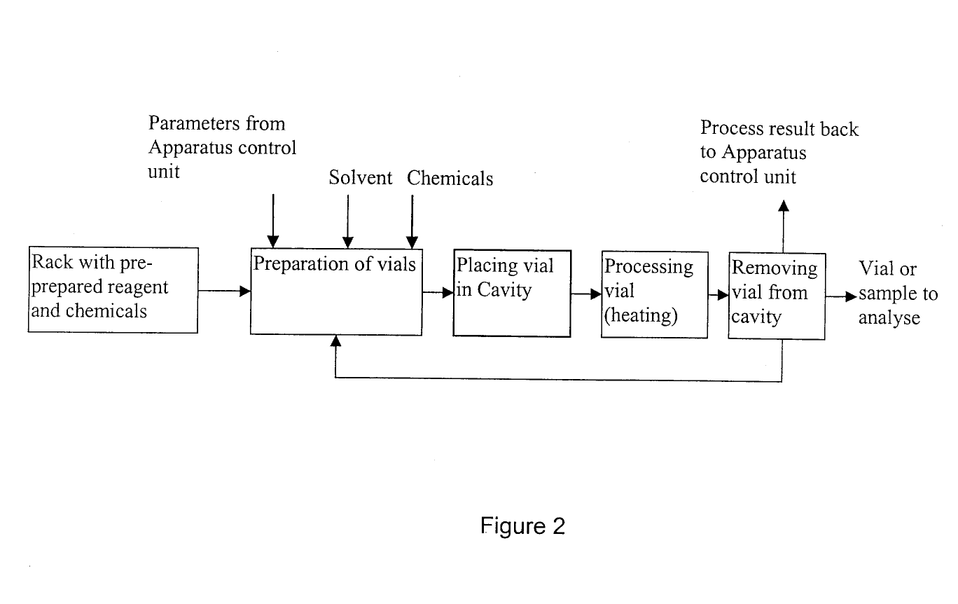

The preparation of reaction mixtures and treatment according to reaction mixtures is exemplarily illustrated in FIG. 2.

### Example 2

The following exemplary product may be synthesised in an exemplary system of the present invention

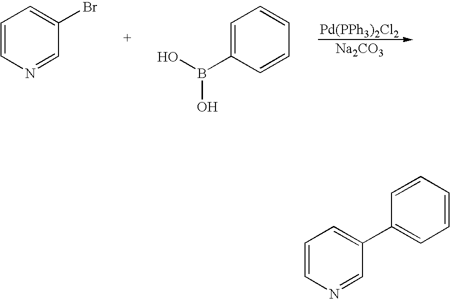

In this reaction, one may search for the transformation of the functionality β in B″ to the functionality δ in product D. To reduce the number of hits, the user may search for a specific product D in combination with the functionality β. One may also search for reactions including both the functionalities β in both B′ and B″. One could also search with any of the functionalities β in both B′ or B″ in combination of A's and/or the functionality α's. If A is palladium, the search may be limited, for example to Suzuki, Negishi etc. type of reactions. The number of hits could then also be limited as described above.

For a number a chemical transformation, where there is a kit available the user may instead be able to retrieve a number of R sets of preselected reaction parameters. For the example above, the user may describe the structure of the chosen substrate. The software may then generate the protocols from predefined reaction parameters. The user then may add the kit into the apparatus at a predefined position and start the run.

In exemplary embodiments, the present invention is directed to an overall system and method as well as one or more several exemplary sub-systems and associated methods. In exemplary embodiments, the subsystems may include a parameter selecting unit, a reaction apparatus, and a database. In an exemplary embodiment, the primary selection unit may be used to construct the desired chemical reactions, based on interaction with the database to select an existing reaction or create a new reaction. The existing reaction, or the new reaction, may be defined by a set of reaction parameters, which may then be sent to a reaction apparatus, such as a heating apparatus, or more specifically, a microwave heating apparatus, in order to conduct the desired reaction.

The results of the reaction may then be returned to the parameter selecting unit and/or the database to thereby update the database. In an exemplary embodiment of the present invention, the parameter selecting unit, the reaction apparatus, and the database are all colocated. In other exemplary embodiments, one or more of these subsystems is remote from the other(s). In another exemplary embodiment, the database is maintained at a remotely located website, hosted by a server, and a user accesses the database via a user interface to download the desired information. Once the user downloads the desired information, the user may construct the desired chemical reaction and send the reaction parameters to the reaction apparatus, which may be further remotely located from the parameter selecting unit. Once the reaction has taken place in the reaction apparatus, the result may be forwarded to the parameter selecting unit and then further uploaded to the database, to update the database itself on the web site. In an exemplary embodiment, the user at the parameter selecting unit freely accesses the database at the remotely located website hosted on a server. In another exemplary embodiment, the user at the parameter selecting unit must pay a subscription fee to access the database at the remotely hosted website. In an exemplary embodiment, the subscription fee may either be period-based (for example, monthly) or transaction-based (per reaction download).

Although exemplary embodiment of the present invention disclose the functionality being divided among certain subsystems or certain devices, such division of functionality could be modified, to be further divided, condensed, or divided in a different fashion, as would be know to one of ordinary skill in the art. Still further, although the system and various subsystems have been described in conjunction with specific elements being implemented in hardware and software, various featuring of the exemplary embodiments of the present invention could be implemented in either hardware or software, as would be know to one of ordinary skill in the art.

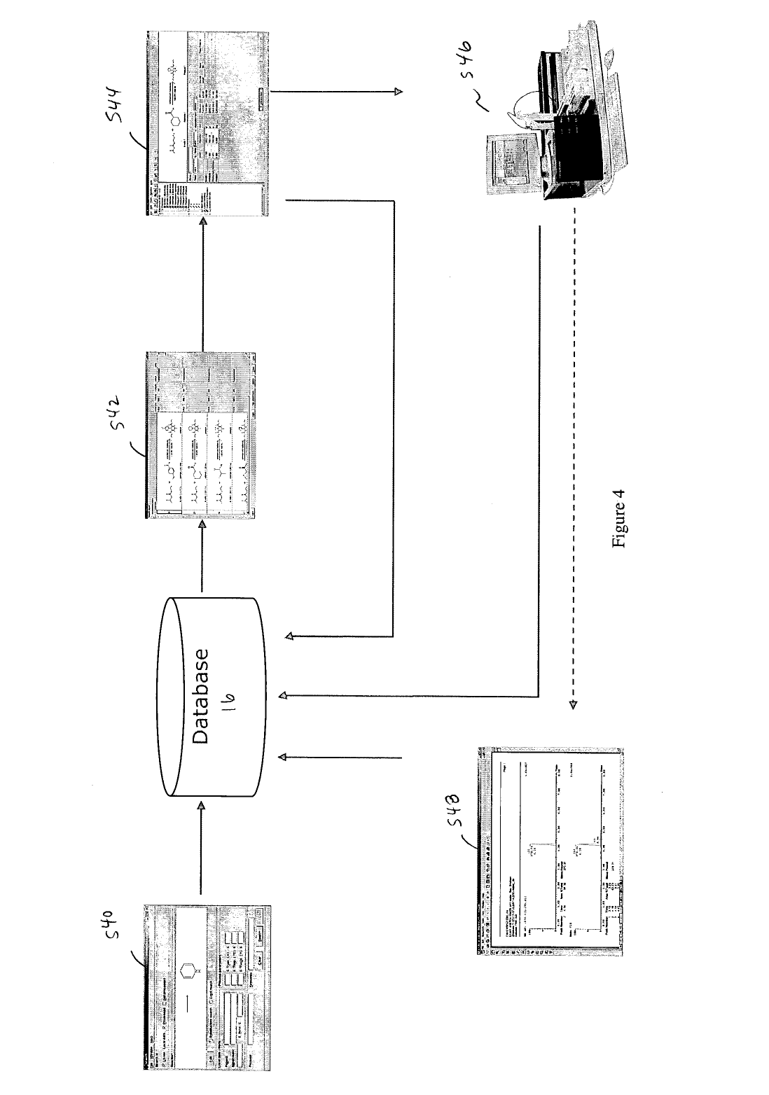

Exemplary embodiments of the present invention are also directed to the workflow or flow of information within an exemplary system or between exemplary subsystems. In an exemplary embodiment, the workflow may proceed as illustrated in FIG. 4 and as set forth below.

1. The database may searched by substructure, keyword or text as shown at step S40. Through the user interface, a query may be constructed with chemical structures and/or keywords for common organic syntheses that may chosen from, for example, a drop-down list.

2. Hits may be browsed, in batches or sequentially as shown at step S42. Everything that matches the query may be shown. The hits can be displayed in a variety of different ways for the user to find the closest match(es) to solve the problem the user wants to answer.

3. Hits are selected as shown at step S42.

After finding the closest match(es), the hit(s) may be selected via a user interface.

4. Create a new experiment as shown at step S44.

Selected hits may be used as templates and a new experiment may be created. The new experiment may be provided to the database, to thereby become searchable as well.

5. The new experiment may be edited and saved as shown at step S44.

6. The experiment may be run in an instrument as shown at step S46. The experiment may be loaded on an instrument, such as a microwave heating apparatus, which may run the experiment according to how the experiment was set up.

7. The new experiment may be documented as shown at step S48. The user syntheses can be documented to include information about e.g. analysis, work-up, etc.

Exemplary embodiments of the present invention are directed to microwave synthesis. Exemplary embodiments of the present invention are directed to a combination of software, a database and instrumentation for microwave synthesis. Exemplary embodiments of the present invention are directed to a system for using microwaves to heat organic synthesis reactions which introduces reproducibility into organic synthesis, even for inexperienced chemists.

In exemplary embodiments of the present invention, the software is capable of operating a microwave system, planning reactions to be performed, searching for reactions in a database, and transferring reactions to the microwave instrument client for execution. In exemplary embodiments of the present invention, the database may be designed to store reaction structures, experiment parameters and other related information in a format usable by the software and the microwave instrument. In exemplary embodiments of the present invention, the microwave instrument is capable of performing time, temperature and pressure controlled organic reactions in a reproducible way.

As a result, reaction and reaction information stored by users can be searched and then copied (and modified if necessary) to serve as a template for the user's next experiment. The modified new experiment can then be launched to the instrument software for execution of the experiment after planning completion. The user can generate a protocol of the experiment to use as a guide when weighing and/or setting up the relevant chemicals in glass vials designed for the instrument. The vials (which may be placed in a vial holder) may then be placed in the instrument, and the already planned and launched experiment can be started. After the reaction is ready and when subsequent analysis, work-up and characterization work have been performed, relevant information can be saved in the database together with the already present reaction information.

The invention being thus described, it will be obvious that the same may be varied in many ways. Such variations are not to be regarded as departure from the spirit and scope of the exemplary embodiments of the present invention, and all such modifications are intended to be included within the scope of the following claims.

1. A method of processing at least one chemical reaction, comprising:
constructing at least one chemical reaction query;
searching at least one database using the at least one chemical reaction query;
receiving at least one hit from the at least one database in response to the at least one chemical reaction query;
selecting at least one desired hit from the at least one hit;
creating the at least one chemical reaction using the at least one desired hit as a template;
conducting the at least one chemical reaction using a reaction apparatus; and
documenting at least one result of the at least one chemical reaction.

2. A method of processing at least one chemical reaction, comprising:
constructing at least one chemical reaction query;
receiving at least one hit from at least one database in response to the at least one chemical reaction query;
selecting at least one desired hit from the at least one hit;
creating the at least one chemical reaction using the at least one desired hit as a template; and
documenting at least one result of the at least one chemical reaction.

3. A method of processing at least one chemical reaction, comprising:
conducting the at least one chemical reaction using at least one desired hit as a template, the at least one desired hit being selected from at least one hit, received from at least one database in response to at least one chemical reaction query.

4. A method of processing at least one chemical reaction, comprising:
receiving at least one chemical reaction query;
searching at least one database using the at least one chemical reaction query; and
generating at least one hit from the at least one database in response to the at least one chemical reaction query;
where at least one desired hit may be selected from the at least one hit, at least one chemical reaction may be created using the at least one desired hit as a template, and the at least one chemical reaction may be used to conduct the at least one chemical reaction using a reaction apparatus.

5. A system for processing at least one chemical reaction, comprising:
at least one database, searchable using at least one chemical reaction query;
a parameter selecting unit for constructing the at least one chemical reaction query, for receiving at least one hit from the at least one database in response to the at least one chemical reaction query, for selecting at least one desired hit from the at least one hit, for creating the at least one chemical reaction using the at least one desired hit as a template; and
a reaction unit for conducting the at least one chemical reaction;
said parameter selecting unit further documenting at least one result of the at least one chemical reaction.

6. A device for processing at least one chemical reaction, comprising:
a reaction constructing unit for constructing the at least one chemical reaction query; and
an interface unit for receiving at least one hit from the at least one database in response to the at least one chemical reaction query;
the reaction constructing unit selecting at least one desired hit from the at least one hit, creating the at least one chemical reaction using the at least one desired hit as a template and documenting at least one result of the at least one chemical reaction.

7. A reaction unit for processing at least one chemical reaction, comprising:
a reaction cavity in which the at least one chemical reaction is conducted using at least one desired hit as a template, the at least one desired hit being selected from at least one hit, received from at least one database in response to at least one chemical reaction query.

8. A database for processing at least one chemical reaction, comprising:
a plurality of chemical reaction templates, wherein in response to at least one chemical reaction query, the plurality of chemical reaction templates may be searched to generate at least one hit,
where at least one desired hit may be selected from the at least one hit, at least one chemical reaction may be created using the at least one desired hit, and the at least one chemical reaction may be supplied to conduct the at least one chemical reaction.

9. The method of claim 4, wherein the step of searching the at least one database is performed using at least one of substructures, keywords, or text.

10. The database of claim 8, wherein the plurality of chemical reaction templates are searched using at least one of substructures, keywords, or text.

11. The method of claim 2, wherein the step of selecting at least one desired hit from the at least one hit is performed sequentially or in a batch manner.

12. The device of claim 6, wherein the step of selecting at least one desired hit from the at least one hit is performed sequentially or in a batch manner.

13. The method of claim 2, wherein the step of selecting at least one desired hit from the at least one hit includes comparing the at least one chemical reaction query to the at least one hit and selected the closest match as the at least one desired hit.

14. The device of claim 6, wherein the step of selecting at least one desired hit from the at least one hit includes comparing the at least one chemical reaction query to the at least one hit and selected the closest match as the at least one desired hit.

15. The method of claim 2, further comprising:
editing the at least one desired hit to create a new reaction template.

16. The device of claim 6, the reaction constructing unit further editing the at least one desired hit to create a new reaction template.

17. The method of claim 4, further comprising:
receiving, storing and making available for future searches, any newly created reaction templates.

18. The database of claim 8, further comprising:
at least one newly created chemical reaction template received, stored and made available for future searches.

19. The method of claim 2, wherein the step of documenting at least one result of the at least one chemical reaction includes documenting at least one of analysis information and work-up information.

20. The device of claim 6, wherein the reaction constructing unit documents at least one result of the at least one chemical reaction by documenting at least one of analysis information and work-up information.
